(19) United States
(12) Patent Application Publication
(10) Pub. No.: US 2009/0012283 A1
(43) Pub. Date: Jan. 8, 2009

(54) Cellulose Acylate Film and Method for Producing Same, and Retardation Film, Polarizer and Liquid Crystal Display Device Comprising the Film

(75) Inventor: Yasuyuki Sasada, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 12/281,579

(22) PCT Filed: Mar. 14, 2007
(86) PCT No.: PCT/JP2007/055786

§ 371 Date: Sep. 3, 2008

(30) Foreign Application Priority Data
Mar. 14, 2006 (JP) 2006-069524

(51) Int. Cl. C08B 3/06

(52) U.S. Cl. 536/83; 536/63; 536/69

(57) ABSTRACT

A cellulose acylate film satisfying Re≧40 is produced by transporting a cellulose acylate film having a substitution degree of acyl substituted for hydroxyl group of cellulose of 2.88 or higher, and subjecting the film to heat treatment at 160° C. or higher.

### TECHNICAL FIELD

The present invention relates to a cellulose acylate film having optical anisotropy and capable of being directly stuck to a polarizing film, and a method for producing thereof, and to a retardation film, a polarizer, and a liquid crystal device using the cellulose acylate film.

### BACKGROUND ART

A polymer film of typically cellulose ester, polyester, polycarbonate, cyclo-olefin polymer, vinyl polymer or polyimide is used in silver halide photographic materials, retardation films, polarizers and image display devices. Films that are more excellent in point of the surface smoothness and the uniformity can be produced from these polymers, and the polymers are therefore widely employed for optical films.

Of those, cellulose ester films having suitable moisture permeability can be directly stuck to most popular polarizing films formed of polyvinyl alcohol (PVA)/iodine in on-line operation. Accordingly, cellulose acylate, especially cellulose acetate is widely employed as a protective film for polarizers.

On the other hand, when cellulose acylate film is applied to optical use, for example, in retardation films, supports for retardation films, protective films for polarizers and liquid crystal display devices, the control of their optical anisotropy is an extremely important element in determining the performance (e.g., visibility) of display devices. With the recent demand for broadening the viewing angle of liquid crystal display devices, improvement of retardation compensation in the devices is desired, for which it is desired to suitably control the in-plane retardation Re (this may be simply referred to as Re) and the thickness-direction retardation Rth (this may be simply referred to as Rth) of the retardation film to be disposed between a polarizing film and a liquid crystal cell. In particular, since the cellulose acylate films satisfying the following formula |Rth|/Re<0.5 are not easy to produce, and it is desired to produce them in a simplified manner. In addition, it is desired to produce cellulose acylate films of which retardation is not varied depending on a measuring environment, particularly a humidity environment.

For a method for producing cellulose acylate films having such an optical property, there is provided a method of sticking a film having a positive Rth to a film having a negative Rth. However, the method is problematic in that the production process can be increased and the variation occurs in the quality of the obtained film.

On the other hand, for a method for producing polymer films, there is proposed a continuous production method in which a polymer film is adhered with a heat-shrinkable film, subjected to heating and stretching treatment, and then the heat-shrinkable film is peeled off (for example, see JP-A-5-157911 and JP-A-2000-231016). According to the examples of these Patent Documents, a polycarbonate film, and the like produced by the method apparently satisfy the following condition, |Rth|/Re<0.5. However, the method is problematic in that a large amount of heat-shrinkable films are consumed and the variation occurs in the quality of the obtained film. The problems are especially distinct for a polymer having a high modulus of elasticity such as cellulose ester.

### DISCLOSURE OF THE INVENTION

An object of the invention is to provide a cellulose acylate film of which Re and Rth can be adjusted within the desired range and which has uniform optical anisotropy and excellent transparency; and to provide a novel film which has such an optical property and is capable of being directly stuck to a polarizing film. In particular, an object of the invention is to provide a cellulose acylate film which satisfies the following formula |Rth|/Re<0.5 and in which a variation is reduced and to provide a method for producing the film. In addition, an object of the invention is to provide a retardation film formed of the cellulose acylate film of the invention; and a polarizer capable of exerting an excellent optical performance by directly sticking the cellulose acylate film of the invention to a polarizing film as a retardation film, a support of a retardation film or a protective film for the polarizer. Further, an object of the invention is to provide a liquid crystal display device formed of the polarizer with a high reliability.

The present inventors have studied extensively and intensively and have found that the problems of the related art can be solved by adjusting the balance between a substitution degree and heat treatment temperature of cellulose acylate which constitutes a cellulose acylate film, and subjecting the cellulose acylate film to heat treatment at the temperature much higher than the general temperature at a drying process. That is, there are provided the following means in order to solve the problems.

[1] A cellulose acylate film which satisfies the following formula (I) and has a substitution degree of acyl substituted for hydroxyl group of cellulose of 2.88 or higher.

Re≧40 Formula (I)

wherein Re indicates a retardation (unit: nm) in the in-plane direction.

[2] The cellulose acylate film described in [1] which satisfies the following formula (II).

|Rth|/Re<0.5 Formula (II)

wherein Re indicates a retardation (unit: nm) in the in-plane direction, and Rth indicates a retardation (unit: nm) in the thickness direction.

[3] The cellulose acylate film described in [1] or [2] which has moisture permeability of 100 to 400 g/(m²·day) at 40° C. and a relative humidity of 90%.

[4] The cellulose acylate film described in any one of items [1] to [3] which has haze of 1.0% or below.

[5] The cellulose acylate film described in any one of items [1] to [4] in which cellulose acylate is cellulose acetate.

[6] A method for producing a cellulose acylate film which comprises transporting a cellulose acylate film having a substitution degree of acyl substituted for hydroxyl group of cellulose of 2.88 or higher, and subjecting the film to heat treatment at 160° C. or higher.

[7] The method for producing a cellulose acylate film described in [6] which comprises subjecting the film to heat treatment at the heating temperature Tp (unit: ° C.) which satisfies the following formula (III).

{−285×S+1000}≦Tp<Tm₀

wherein S indicates a substitution degree of acyl group substituted for hydroxyl group of cellulose and Tm₀ (unit: ° C.) indicates the melting point of cellulose acylate before being subjected to the heat treatment.

[8] The method for producing a cellulose acylate film described in [6] or [7] in which the cellulose acylate film is formed from dope obtained through a process of cooling a mixture containing cellulose acylate and a halogen-containing organic solvent at temperature in the range of −100 to 100° C.

[9] The method for producing a cellulose acylate film described in [6] or [7] in which the mixture containing cellulose acylate and a halogen-containing organic solvent is subjected to at least one of the following methods (a) and (b) to dissolve the cellulose acylate in the solvent, and then the film is formed.

(a): A mixture is swollen at −10 to 39° C., and then heated at 0 to 39° C.

(b): A mixture is swollen at −10 to 39° C., and then heated at 40 to 240° C. under pressure of 0.2 to 30 MPa. After that, the mixture is cooled at 0 to 39° C.

[10] The cellulose acylate film described in any one of items [1] to [5] which is produced according to the producing method described in any one of items [6] to [9].

[11] The cellulose acylate film described in any one of items [1] to [5] or [10] which has a fluctuation range of below 5° in the slow phase axis direction.

[12] The cellulose acylate film described in any one of items [1] to [5], [10], or [11] which has a monolayer structure.

[13] A retardation film which has at least one sheet of the cellulose acylate film described in any one of items [1] to [5] or [10] to [12].

[14] A polarizer which has at least one sheet of the cellulose acylate film described in any one of items [1] to [5] or [10] to [12].

[15] The polarizer described in [14] in which the cellulose acylate film is directly stuck to a polarizing film.

[16] A liquid crystal display device which has at least one sheet of the cellulose acylate film described in any one of items [1] to [5] or [10] to [12], the retardation film described in [13], and the polarizer described in [14] or [15].

Since a cellulose acylate film of the present invention of which Re and Rth can be adjusted within the desired range has uniform optical anisotropy, excellent transparency, and suitable moisture permeability, it is possible to stick the film to a polarizing film in on-line operation. Specifically, by using cellulose acylate having a high substitution degree of acyl, the film can obtain desired optical anisotropy by a relatively simple operation. For that reason, it is possible to provide a polarizer excellent in visibility with a high productivity. In particular, according to the invention, it is possible to produce a cellulose acylate film which satisfies the following formula |Rth|/Re<0.5 and in which a variation is reduced; and to provide an excellent retardation film. In addition, it is possible to provide a liquid crystal display device having a high reliability.

### BEST MODE FOR CARRYING OUT THE INVENTION

Described in detail hereinafter are the cellulose acylate film and the method for producing it, the retardation film, the polarizer and the liquid crystal display device of the invention. The constituent features may be described below on the basis of representative embodiments of the invention, but the invention is not limited to such embodiments. The numerical range represented by “-” herein means a range including the numerical values described before and after “-” as the lowermost value and the uppermost value, respectively.

### <<Cellulose Acylate Film>>

The cellulose acylate film of the invention satisfies the following formula (I).

Re≧40 Formula (I)

where Re and Rth represent retardations (unit: nm) in the in-plane direction and in the thickness direction, respectively.

### [Retardation]

The retardation in the invention is described. In this description, Re and Rth (unit: nm) are obtained according to the following method. A film to be analyzed is conditioned at 25° C. and a relative humidity of 60% for 24 hours. Using a prism coupler (Model 2010 Prism Coupler, by Metricon) and using a He—Ne laser at 632.8 nm, the mean refractivity (n) of the film, which is represented by the following formula (a), is obtained at 25° C. and a relative humidity of 60%.

n=(n_{TE}×2+n_{TM})/3 (a)

wherein n_{TE} is the refractive index measured with polarizing light in the in-plane direction of the film; and n_{TM} is the refractive index measured with polarizing light in the normal direction to the face of the film.

Next, using a birefringence meter (ABR-10A, by Uniopt) and using a He—Ne laser at 632.8 nm, the slow axis and the retardation of the conditioned film are determined at 25° C. and a relative humidity of 60% both in the vertical direction relative to the film surface and in the direction inclined by ±40° from the normal line to the film face relative to the slow axis direction in the film as the inclination axis (rotation axis). Then, using the mean refractive index obtained in the above, nx, ny and nz are computed. According to the following formulae (b) and (c), the in-plane retardation (Re) and the thickness-direction retardation (Rth) of the film are computed:

Re=(nx−ny)×d (b)

Rth={(nx+ny)/2−nz}×d (c)

wherein nx is the refractive index in the slow axis (x) direction of the film face; ny is the refractive index in the direction perpendicular to the direction x of the film face; nz is the refractive index in the thickness direction of the film (in the normal direction of the film face); d is the thickness (nm) of the film; and the slow axis is in the direction in which the refractive index is the largest in the film face.

The retardation of the cellulose acylate film of the invention satisfies the above formula (I). The retardation of the cellulose acylate film of the invention satisfying the formula (I) preferably satisfies the above formula (II) and more preferably satisfies the following formula (Ia) and (IIa):

50≦Re≦600 Formula (Ia)

|Rth|/Re<0.5 Formula (IIa)

More preferably, the cellulose acylate film of the invention satisfies the following formula (Ib) and (IIb):

100≦Re≦400 Formula (Ib)

|Rth|/Re<0.4 Formula (IIb)

Still more preferably, the cellulose acylate film of the invention satisfies the following formula (Ic) and (IIc):

150≦Re≦300 Formula (Ic)

|Rth|/Re<0.3 Formula (IIc)

In the invention, the angle θ formed between the transfer direction and the slow phase axis of Re of the film is preferably 0±10° or 90±10°, more preferably 0±5° or 90±5°, even more preferably 0±3° or 90±3°, and as the case may be, it is preferably 0±1° or 90±1°, most preferably 90±1°.

### [Thickness]

The thickness of the cellulose acylate film of the invention is preferably 20 μm-180 μm, more preferably 40 μm-160 μm, even more preferably 60 μm-140 μm. When the thickness is less than 20 μm, the handling ability upon processing the film for a polarizer, or the curing of the polarizer is undesirable. The thickness unevenness of the cellulose acylate film of the invention is preferably 0-2%, more preferably 0-1.5%, especially preferably 0-1%, in both of the transfer direction and the width direction.

### [Moisture Permeability]

Next, moisture permeability is described. The moisture permeability in the invention means an evaluated value from the mass change (g/(m²·day)) before and after humidity conditioning when respective films are used for capping and sealing cups containing calcium chloride to be left under conditions of 40° C. and a relative humidity of 90% for 24 hours.

The moisture permeability rises with the rise of temperature, and also with the rise of humidity, but the relation between the magnitudes of the moisture permeability of films is changeless independently of respective conditions. Therefore, in the invention, the value of mass change at 40° C. and a relative humidity of 90% is employed as the standard.

The moisture permeability of the cellulose acylate film of the invention is 100-400 g/(m²·day). The use of a film having the moisture permeability of 100-400 g/(m²·day) allows the film to be stuck directly to a polarizing film. The moisture permeability is preferably 100-350 g/(m²·day), more preferably 150-300 g/(m²·day).

### [Haze]

According to the invention, the cellulose acylate film is stored in a humidity conditioning for 24 hours at 25° C. and a relative humidity of 60%, and then haze of the film is measured by the use of a Hazemeter (Model NDH 2000, manufactured by Nippon Denshoku Kogyo Co., Ltd.)

As described in the invention, it is preferred that a film used for a liquid crystal display device and an optical film has a low haze value. In order to lower the haze value of the film, for example, the balance between a substitution degree and heat treatment temperature of cellulose acylate which constitutes the cellulose acylate film is controlled. The haze of the cellulose acylate film of the invention is preferably 1% or below, more preferably in the range of 0.0 to 0.8%, even more preferably in the range of 0.0 to 0.5%, and most preferably in the range of 0.1 to 0.3%.

### [Tm₀]

20 mg of a sample is put into a DSC pan, and the pan is heated from 30° C. up to 120° C. in a nitrogen atmosphere at a rate of 10° C./min and maintained for 15 minutes, and then cooled down to 30° C. at a rate of −20° C./min. Next, the pan is again heated from 30° C. up to 300° C., and the initiation temperature at which the endothermic peak is appeared is referred to as Tm₀ of the film.

### [Cellulose Acylate]

Examples of the polymer which is the constitutive element of the cellulose acylate film of the invention include a cellulose acylate compound, and a compound having acyl-substituted cellulose skeleton obtained by biologically or chemically introducing a functional group into a basic material, which is cellulose.

The polymer may be powdery or granular, or may be pelletized.

Preferably, the water content of the polymer is at most 1.0% by mass, more preferably at most 0.7% by mass, most preferably at most 0.5% by mass. As the case may be, the water content may be preferably at most 0.2% by mass. In case where the water content of the polymer is outside the preferred range, then it is desirable that the polymer is dried by heating before use.

One or more such polymers may be used herein either singly or as combined.

Cellulose acylate is preferably used for the main component polymer of the cellulose acylate film of the invention. The “main component polymer” as referred to herein is meant to indicate the polymer itself when the film is formed of a single polymer, and when the film is formed of different polymers, then it indicates the polymer having the highest mass fraction of all the polymers constituting the film.

The cellulose acylate is an ester of cellulose with an carboxylic acid. The acid to constitute the ester is preferably a fatty acid having from 2 to 22 carbon atoms, more preferably a lower fatty acid having from 2 to 4 carbon atoms.

In the cellulose acylate, all or a part of the hydrogen atoms of the hydroxyl groups existing at the 2-, 3- and 6-positions of the glucose unit constituting the cellulose are substituted with an acyl group. Examples of the acyl group are acetyl, propionyl, butyryl, isobutyryl, pivaloyl, heptanoyl, hexanoyl, octanoyl, decanoyl, dodecanoyl, tridecanoyl, tetradecanoyl, hexadecanoyl, octadecanoyl, cyclohexanecarbonyl, oleoyl, benzoyl, naphthylcarbonyl and cinnamoyl. The acyl group is preferably acetyl, propionyl, butyryl, dodecanoyl, octadecanoyl, pivaloyl, oleoyl, benzoyl, naphthylcarbonyl, cinnamoyl, most preferably acetyl, propionyl, butyryl.

The cellulose ester may be an ester of cellulose with different carboxylic acids. The cellulose acylate may be substituted with different acyl groups.

For the cellulose acylate film of the invention, a substitution degree of acyl is preferably 2.88 or higher from the viewpoint of improving expression in Re, or reducing in the moisture permeability and the heat treatment temperature. Since the expression in Re is improved as the substitution degree of acyl increases even at the same heat treatment temperature, the heat treatment temperature may be controlled to be relatively lower depending on the targeted Re. It is more preferred that cellulose acylate has the substitution degree of acyl of 2.89 to 2.99, even more preferably 2.90 to 2.98, most preferably 2.92 to 2.97.

Regarding a method for producing cellulose acylate, its basic principle is described in Wood Chemistry by Nobuhiko Migita et al., pp. 180-190 (Kyoritsu Publishing, 1968). One typical method for producing cellulose acylate is a liquid-phase acylation method with carboxylic acid anhydride-carboxylic acid-sulfuric acid catalyst. Concretely, a starting material for cellulose such as cotton linter or woody pulp is pretreated with a suitable amount of a carboxylic acid such as acetic acid, and then put into a previously-cooled acylation mixture for esterification to produce a complete cellulose acylate (in which the overall substitution degree of acyl group in the 2-, 3- and 6-positions is nearly 3.00). The acylation mixture generally includes a carboxylic acid serving as a solvent, a carboxylic acid anhydride serving as an esterifying agent, and sulfuric acid serving as a catalyst. In general, the amount of the carboxylic acid anhydride to be used in the process is stoichiometrically excessive over the overall amount of water existing in the cellulose that reacts with the anhydride and that in the system.

Next, after the acylation, the excessive carboxylic acid anhydride still remaining in the system is hydrolyzed, for which, water or water-containing acetic acid is added to the system. Then, for partially neutralizing the esterification catalyst, an aqueous solution that contains a neutralizing agent (e.g., carbonate, acetate, hydroxide or oxide of calcium, magnesium, iron, aluminium or zinc) may be added thereto. Then, the resulting complete cellulose acylate is saponified and ripened by keeping it at 20 to 90° C. in the presence of a small amount of an acylation catalyst (generally, sulfuric acid remaining in the system), thereby converting it into a cellulose acylate having a desired substitution degree of acyl group and a desired polymerization degree. At the time when the desired cellulose acylate is obtained, the catalyst still remaining in the system is completely neutralized with the above-mentioned neutralizing agent; or the catalyst therein is not neutralized, and the cellulose acylate solution is put into water or diluted acetic acid (or water or diluted acetic acid is put into the cellulose acylate solution) to thereby separate the cellulose acylate, and thereafter this is washed and stabilized to obtain the intended product, cellulose acylate.

Preferably, the polymerization degree of the cellulose acylate is from 150 to 500 as the viscosity-average polymerization degree thereof, more preferably from 200 to 400, even more preferably from 220 to 350. The viscosity-average polymerization degree may be measured according to a limiting viscosity method by Uda et al. (Kazuo Uda, Hideo Saito; Journal of the Fiber Society of Japan, Vol. 18, No. 1, pp. 105-120, 1962). The method for measuring the viscosity-average polymerization degree is described also in JP-A-9-95538.

Cellulose acylate where the amount of low-molecular components is small may have a high mean molecular weight (high polymerization degree), but its viscosity may be lower than that of ordinary cellulose acylate. Such cellulose acylate where the amount of low-molecular components is small may be obtained by removing low-molecular components from cellulose acylate produced in an ordinary method. The removal of low-molecular components may be attained by washing cellulose acylate with a suitable organic solvent. Cellulose acylate where the amount of low-molecular components is small may be obtained by synthesizing it. In case where cellulose acylate where the amount of low-molecular components is small is synthesized, it is desirable that the amount of the sulfuric acid catalyst in acylation is controlled to be from 0.5 to 25 parts by mass relative to 100 parts by mass of cellulose. When the amount of the sulfuric acid catalyst is controlled to fall within the range, then cellulose acylate having a preferable molecular weight distribution (uniform molecular weight distribution) can be produced.

The starting material, cotton for cellulose ester and methods for producing it are described also in Hatsumei Kyokai Disclosure Bulletin (No. 2001-1745, issued Mar. 15, 2001, Hatsumei Kyokai), pp. 7-12.

### [Production of Cellulose Acylate Film]

The cellulose acylate film of the invention may be produced from a cellulose acylate solution that contains cellulose acylate and various additives, according to a method of solution casting film formation. In case where the melting point of the cellulose acylate of the invention or the melting point of a mixture of the cellulose acylate with various additives is lower than the decomposition temperature thereof and is higher than the stretching temperature thereof, then the polymer film may also be produced according to a method of melt film formation. The cellulose acylate film of the invention may be produced according to such a method of melt film formation, and the method of melt film formation is described in JP-A-2000-352620.

### [Cellulose Acylate Solution]

### (Solvent)

The cellulose acylate film of the invention may be produced, for example, according to a method of solution casting film formation where a cellulose acylate solution that contains a polymer and optionally various additives is cast into a film.

The main solvent of the cellulose acylate solution to be used in producing the cellulose acylate film of the invention is preferably an organic solvent that is a good solvent for the cellulose acylate. The organic solvent of the type is preferably one having a boiling point of not higher than 80° C. from the viewpoint of reducing the load in drying. More preferably, the organic solvent has a boiling point of from 10 to 80° C., even more preferably from 20 to 60° C. As the case may be, an organic solvent having a boiling point of from 30 to 45° C. may also be preferably used for the main solvent.

The main solvent includes halogenohydrocarbons, esters, ketones, ethers, alcohols and hydrocarbons, which may have a branched structure or a cyclic structure. The main solvent may have two or more functional groups of any of esters, ketones, ethers and alcohols (i.e., —O—, —CO—, —COO—, —OH). Further, the hydrogen atoms in the hydrocarbon part of these esters, ketones, ethers and alcohols may be substituted with a halogen atom (especially, fluorine atom). Regarding the main solvent of the cellulose acylate solution to be used in producing the cellulose acylate film of the invention, when the solvent of the solution is a single solvent, then it is the main solvent, but when the solvent is a mixed solvent of different solvents, then the main solvent is the solvent having the highest mass fraction of all the constitutive solvents.

The halogenohydrocarbon is preferably a chlorohydrocarbon, including dichloromethane and chloroform, and dichloromethane is more preferred.

The ester includes, for example, methyl formate, ethyl formate, methyl acetate, ethyl acetate.

The ketone includes, for example, acetone, methyl ethyl ketone.

The ether includes, for example, diethyl ether, methyl tert-butyl ether, diisopropyl ether, dimethoxymethane, 1,3-dioxolan, 4-methyldioxolan, tetrahydrofuran, methyltetrahydrofuran, 1,4-dioxane.

The alcohol includes, for example, methanol, ethanol, 2-propanol.

The hydrocarbon includes, for example, n-pentane, cyclohexane, n-hexane, benzene, toluene.

The organic solvent that may be combined with the main solvent includes halogenohydrocarbons, esters, ketones, ethers, alcohols and hydrocarbons, which may have a branched structure or a cyclic structure. The organic solvent may have two or more functional groups of any of esters, ketones, ethers and alcohols (i.e., —O—, —CO—, —COO—, —OH). Further, the hydrogen atoms in the hydrocarbon part of these esters, ketones, ethers and alcohols may be substituted with a halogen atom (especially, fluorine atom).

The halogenohydrocarbon is preferably a chlorohydrocarbon, including dichloromethane and chloroform, and dichloromethane is more preferred.

The ester includes, for example, methyl formate, ethyl formate, propyl formate, pentyl formate, methyl acetate, ethyl acetate, pentyl acetate.

The ketone includes, for example, acetone, methyl ethyl ketone, diethyl ketone, diisobutyl ketone, cyclopentanone, cyclohexanone, methylcyclohexanone.

The ether includes, for example, diethyl ether, methyl tert-butyl ether, diisopropyl ether, dimethoxymethane, dimethoxyethane, 1,4-dioxane, 1,3-dioxolan, 4-methyldioxolan, tetrahydrofuran, methyltetrahydrofuran, anisole, phenetole.

The alcohol includes, for example, methanol, ethanol, 1-propanol, 2-propanol, 1-butanol, 2-butanol, tert-butanol, 1-pentanol, 2-methyl-2-butanol, cyclohexanol, 2-fluoroethanol, 2,2,2-trifluoroethanol, 2,2,3,3-tetrafluoro-1-propanol.

The hydrocarbon includes, for example, n-pentane, cyclohexane, n-hexane, benzene, toluene, xylene.

The organic solvent having two or more different types of functional groups includes, for example, 2-ethoxyethyl acetate, 2-methoxyethanol, 2-butoxyethanol, methyl acetacetate.

It is desirable that the total solvent for it contains from 5% to 30% by mass, more preferably from 7% to 25% by mass, even more preferably from 10% to 20% by mass of alcohol from the viewpoint of reducing the load for film peeling from band.

Preferred examples of the combination of organic solvents for use as the solvent in the cellulose acylate solution to be used in producing the cellulose acylate film of the invention are mentioned below, to which, however, the invention should not be limited. The numerical data for ratio are parts by mass.

### (1) Dichloromethane/methanol/ethanol/butanol=80/10/5/5

### (2) Dichloromethane/methanol/ethanol/butanol=80/5/5/10

(3) Dichloromethane/isobutyl alcohol=90/10

### (4) Dichloromethane/acetone/methanol/propanol=80/5/5/10

### (5) Dichloromethane/methanol/butanol/cyclohexane=80/8/10/2

(6) Dichloromethane/methyl ethyl ketone/methanol/butanol=80/10/5/5

### (7) Dichloromethane/butanol=90/10

(8) Dichloromethane/acetone/methyl ethyl ketone/ethanol/butanol=68/10/10/7/5

### (9) Dichloromethane/cyclopentanone/methanol/pentanol=80/2/15/3

(10) Dichloromethane/methyl acetate/ethanol/butanol=70/12/15/3
(11) Dichloromethane/methyl ethyl ketone/methanol/butanol=80/5/5/10
(12) Dichloromethane/methyl ethyl ketone/acetone/methanol/pentanol=50/20/15/5/10
(13) Dichloromethane/1,3-dioxolan/methanol/butanol=70/15/5/10

### (14) Dichloromethane/dioxane/acetone/methanol/butanol=75/5/10/5/5

(15) Dichloromethane/acetone/cyclopentanone/ethanol/isobutyl alcohol/cyclohexanone=60/18/3/10/7/2
(16) Dichloromethane/methyl ethyl ketone/acetone/isobutyl alcohol=70/10/10/10
(17) Dichloromethane/acetone/ethyl acetate/butanol/hexane=69/10/10/10/1
(18) Dichloromethane/methyl acetate/methanol/isobutyl alcohol=65/15/10/10

### (19) Dichloromethane/cyclopentanone/ethanol/butanol=85/7/3/5

### (20) Dichloromethane/methanol/butanol=83/15/2

### (21) Dichloromethane=100

### (22) Acetone/ethanol/butanol=80/15/5

(23) Methyl acetate/acetone/methanol/butanol=75/10/10/5
(24) 1,3-dioxolan=100

### (25) Dichloromethane/methanol=92/8

### (26) Dichloromethane/methanol=90/10

### (27) Dichloromethane/methanol=87/13

### (28) Dichloromethane/ethanol=90/10

A detailed description of a case where a non-halogen organic solvent is the main solvent is given in Hatsumei Kyokai Disclosure Bulletin (No. 2001-1745, issued Mar. 15, 2001, Hatsumei Kyokai), which may be conveniently referred to herein.

### (Solution Concentration)

The polymer concentration in the cellulose acylate solution to be prepared herein is preferably from 5% to 40% by mass, more preferably from 10% to 30% by mass, most preferably from 15% to 30% by mass.

The polymer concentration may be so controlled that it could be a predetermined concentration in the stage where polymer is dissolved in solvent. Apart from it, a solution having a low concentration (e.g., from 4% to 14% by mass) is previously prepared, and then it may be concentrated by evaporating the solvent from it. On the other hand, a solution having a high concentration is previously prepared, and it may be diluted. The polymer concentration in the solution may also be reduced by adding additive thereto.

### (Additive)

The cellulose acylate solution to be used for producing the cellulose acylate film of the invention may contain various liquid or solid additives in accordance with the use of the film, in the steps of producing it. Examples of the additives are plasticizer (its preferred amount is from 0.01% to 10% by mass of the polymer—the same shall apply hereunder), UV absorbent (0.001% to 1% by mass), powdery particles having a mean particle size of from 5 to 3000 nm (0.001% to 1% by mass), fluorine-containing surfactant (0.001% to 1% by mass), release agent (0.0001% to 1% by mass), antioxidant (0.0001% to 1% by mass), optical anisotropy-controlling agent (0.01% to 10% by mass), IR absorbent (0.001% to 1% by mass).

The plasticizer and the optical anisotropy-controlling agent are compounds having both a hydrophobic part and a hydrophilic part. These compounds are aligned between the polymer chains, thereby changing the retardations of the film. When the compounds are combined with cellulose acylate that is especially preferably used in the invention, the compounds may improve the hydrophobicity of the film and may reduce the humidity-dependent change of the retardation thereof. In addition, when the compounds are combined with the UV absorbent or IR absorbent, the compounds may effectively control the wavelength dependence of the retardation of the polymer film. The additives to be used in the cellulose acylate film of the invention are preferably those not substantially evaporating in the step of drying the film.

From the viewpoint of reducing the humidity-dependent retardation change of the film, the amount of these additives to be added to the film is preferably larger, but with the increase in the amount to be added, there may occur some problems in that the glass transition temperature of the polymer film may lower and the additives may evaporate away during the process of film production. Accordingly, in case where cellulose acetate which is preferably used in the invention is used as the polymer, then the amount of the plasticizer or the optical anisotropy-controlling agent to be added is preferably in the range of 0.01% to 30% by mass, more preferably in the range of 2% to 30% by mass, even more preferably in the range of 5% to 20% by mass relative to the polymer.

For the plasticizer or the optical anisotropy-controlling agent which can be suitably used in case that cellulose acylate is used as a polymer which constitutes the cellulose acylate film, specifically, there can be exemplified a plasticizer described in JP-A-2005-104148 on pages 33 to 34, and an optical anisotropy-controlling agent described in JP-A-2005-104148 on pages 38 to 89. For the IR absorbent, it is described in JP-A-2001-194522. The time of adding the additives may be properly determined depending on the types of the additives. For the additives, it is described in Hatsumei Kyokai Disclosure Bulletin (No. 2001-1745, issued Mar. 15, 2001, Hatsumei Kyokai) on pages 16 to 22.

### (Preparation of Cellulose Acylate Solution)

The cellulose acylate solution may be prepared, for example, according to the methods described in JP-A-58-127737, JP-A-61-106628, JP-A-2-276830, JP-A-4-259511, JP-A-5-163301, JP-A-9-95544, JP-A-10-45950, JP-A-10-95854, JP-A-11-71463, JP-A-11-302388, JP-A-11-322946, JP-A-11-322947, JP-A-11-323017, JP-A-2000-53784, JP-A-2000-273184 and JP-A-2000-273239. Concretely, cellulose acylate and solvent are mixed and stirred so that the cellulose acylate is swollen, and as the case may be, this is cooled or heated so as to dissolve the cellulose acylate, and thereafter this is filtered to obtain a cellulose acylate solution.

According to the invention, in order to improve solubility of cellulose acylate in a solvent, there is included a process of cooling and/or heating a mixture of cellulose acylate and a solvent.

In case of cooling the mixture of cellulose acylate and a solvent in which a halogen-containing organic solvent is used as the solvent, it is preferred to include a process of cooling the mixture at −100 to 10° C. Further, it is preferred to include a process of swelling the mixture at −10 to 39° C. before the process of cooling, and a process of heating the mixture at 0 to 39° C. after the process of cooling.

In case of heating the mixture of cellulose acylate and a solvent in which a halogen-containing organic solvent is used as the solvent, it is preferred to include a process of dissolving the cellulose acylate in the solvent according to at least one of the following methods (a) and (b).

(a): A mixture is swollen at −10 to 39° C., and then heated at 0 to 39° C.

(b): A mixture is swollen at −10 to 39° C., and then heated at 40 to 240° C. under pressure of 0.2 to 30 MPa. After that, the mixture is cooled at 0 to 39° C.

In addition, in case of cooling the mixture of cellulose acylate and a solvent in which a non-halogen-containing organic solvent is used as the solvent, it is preferred to include a process of cooling the mixture at −100 to −10° C. Further, it is preferred to include a process of swelling the mixture at −10 to 55° C. before the process of cooling, and a process of heating the mixture at 0 to 57° C. after the process of cooling.

In case of heating the mixture of cellulose acylate and a solvent in which a non-halogen-containing organic solvent is used as the solvent, it is preferred to include a process of dissolving the cellulose acylate in the solvent according to at least one of the following methods (c) and (d).

(c): A mixture is swollen at −10 to 55° C., and then heated at 0 to 57° C.

(d): A mixture is swollen at −10 to 55° C., and then heated at 40 to 240° C. under pressure of 0.2 to 30 MPa. After that, the mixture is cooled at 0 to 57° C.

### [Casting, Drying]

The cellulose acylate film of the invention may be produced according to a conventional method of solution casting film formation, using a conventional apparatus for solution casting film formation. Concretely, a dope (polymer solution) prepared in a dissolver (tank) is filtered, and then once stored in a storage tank in which the dope is degassed to be a final dope. The dope is kept at 30° C., and fed into a pressure die from the dope discharge port of the tank, via a metering pressure gear pump through which a predetermined amount of the dope can be fed with accuracy, for example, based on the controlled revolution thereof, and then the dope is uniformly cast onto the metal support of a casting unit that runs endlessly, via the slit of the pressure die (casting step). Next, at a peeling point at which the metal support reaches almost after having traveled round the drum, a semi-dried dope film (this may be referred to as a web) is peeled from the metal support, and then transported to a drying zone in which the web is dried while conveyed with rolls therein. In this invention, the metal support is preferably a metal belt or metal drum.

Thus dried film has a residual solvent amount of preferably 0-2% by mass, more preferably 0-1% by mass. This film may be directly transported to a stretching zone or heat treatment zone, or may be wound and then subjected to stretching or heat treatment in off-line operation. The film has a width of preferably 0.5-5 m, more preferably 0.7-3 m. When the film is once wound, the wound length is preferably 300-30000 m, more preferably 500-10000 m, even more preferably 1000-7000 m.

### [Heat Treatment]

In the invention, in order to attain targeted Re and Rth, the formed cellulose acylate film is subjected to the heat treatment.

### (Temperature)

The method for producing a cellulose acylate film of the invention comprises a process of transporting a cellulose acylate film having a substitution degree of acyl substituted for hydroxyl group of cellulose of 2.88 or higher, and subjecting the film to heat treatment at 160° C. or higher. The temperature at the heat treatment is preferably 180-280° C., more preferably 200-270° C., still more preferably 220-250° C. The temperature at the heat treatment is preferably determined in view of the substitution degree of the cellulose acylate included in the cellulose acylate film. More specifically, the temperature at the heat treatment preferably satisfies the following formula (III), more preferably satisfies the following formula (IV), and still more preferably satisfies the following formula (V):

{−285×S+1000}≦Tp<Tm₀ Formula (III)

{−285×S+1010}≦Tp<Tm₀−5 Formula (IV)

{−285×S+1020}≦Tp<Tm₀−10 Formula (V)

where S represents a substitution degree of acetyl group substituted for hydroxyl group of cellulose, and Tm₀ (unit: ° C.) indicates the melting point of cellulose acylate before being subjected to the heat treatment.

By setting the heat treatment temperature as mentioned above, it is possible to produce the cellulose acylate film of the invention which satisfies the following formula, |Rth|/Re<0.5, which was not easily produced in the past.

### [Stretching]

In order to adjust the value of Re and Rth, it is preferred that the cellulose acylate film being transported into a heat treatment zone is subjected to the heat treatment and the stretching at the same time, or the cellulose acylate film is subjected to the stretching after being subjected to the heat treatment.

### (Stretching Method)

For the stretching, longitudinal stretching may be carried out, for example, in the apparatuses having a heating zone between two or more apparatuses (for example, nip rolls, suction drum) which maintains the film in transport direction, in which the circumferential velocity on an exit side is larger, or stretching by grasping the both ends of the film with tenter clips for widening the film in the direction perpendicular to the transport direction may be carried out. Otherwise, the above both stretching method may be carried out in combination thereof.

The stretching ratio can be arbitrarily set in accordance with the retardation desired for the film, and is preferably in the range of 3 to 500%, more preferably in the range of 5 to 100%, even more preferably in the range of 10 to 80%, and especially preferably in the range of 20 to 60%. The stretching may be effected in one step operation or multi-step operation. The ‘stretching ratio (%)’ herein means a value obtained by using the following formula.

Stretching ratio (%)=100×{(length after stretching)−(length before stretching)}/length before stretching

The stretching velocity in the stretching is preferably in the range of 10 to 10000%/min, more preferably in the range of 20 to 1000%/min, and even more preferably in the range of 30 to 800%/min.

In case that the cellulose acylate film is subjected to the stretching after being subjected to the heat treatment, first, the film may be cooled after the heat treatment and then subjected to the stretching process. In such a case, it is preferred that the film is subjected to the heat treatment by being transported to and then passed through the heat treatment zone; and the film is subjected to the stretching by grasping the both ends of the film with chucks for widening the film in the direction perpendicular to the transport direction.

The cooling temperature is lower than the heat treatment temperature by preferably at least 50° C., more preferably in the range of 100 to 300° C., even more preferably 150 to 250° C.

The difference between the heat treatment temperature and the stretching temperature is preferably at least 1° C., more preferably 10 to 200° C., even more preferably 30 to 150° C., especially preferably 50 to 100° C. The stretching temperature is preferably lower than the heat treatment temperature. By suitably setting the temperature difference, the value of Rth/Re can be controlled.

The cellulose acylate film of the invention has preferably a monolayer structure. A film having a monolayer structure is a polymer film of one sheet, instead of one composed of a plurality of stuck film materials. Also included is one sheet of polymer film produced from a plurality of polymer solutions by a sequential flow casting system or co-flow casting system. In this case, a polymer film having a distribution in the thickness direction can be obtained by suitably adjusting the type or blending amount of an additive, the molecular weight distribution of the polymer, or the type of the polymer, etc. Also included is a film having various functional portions such as an optical anisotropic portion, an antiglare portion, a gas barrier portion or a moisture resistant portion in one film.

### [Surface Treatment]

The cellulose acylate film of the invention may be surface-treated in any desired manner to thereby improve its adhesiveness to various functional layers (e.g., undercoat layer, back layer, optically anisotropic layer). The surface treatment includes glow discharge treatment, UV irradiation treatment, corona treatment, flame treatment, saponification treatment (acid saponification treatment, alkali saponification treatment). In particular, glow discharge treatment and alkali saponification treatment are preferred. The “glow discharge treatment” as referred to herein is a plasma treatment of treating a film surface in the presence of a plasma-exciting vapor. The details of the surface treatment are described in Hatsumei Kyokai Disclosure Bulletin (No. 2001-1745, issued Mar. 15, 2001, Hatsumei Kyokai), and may be conveniently referred to herein.

For improving the adhesiveness between the film surface of the cellulose acylate film of the invention and a functional layer to be formed thereon, an undercoat layer (adhesive layer) may be formed on the film in place of or in addition to the surface treatment as above. The undercoat layer is described in Hatsumei Kyokai Disclosure Bulletin (No. 2001-1745, issued Mar. 15, 2001, Hatsumei Kyokai), page 32, which may be conveniently referred to herein. Functional layers that may be formed on the cellulose acylate film of the invention are described in Hatsumei Kyokai Disclosure Bulletin (No. 2001-1745, issued Mar. 15, 2001, Hatsumei Kyokai), pp. 32-45, which may be conveniently referred to herein.

### <<Retardation Film>>

The cellulose acylate film of the invention may be used as a retardation film. “Retardation film” means an optical material that is generally used in display devices such as liquid crystal display devices and has optical anisotropy, and its meaning may be the same as that of retarder, optical compensatory film, and optical compensatory sheet. In a liquid crystal display device, the retardation film is used for the purpose of increasing the contrast of the display panel and improving the viewing angle characteristic and the coloration thereof.

Using the cellulose acylate film of the invention makes it easy to produce a retardation film of which Re and Rth can be controlled in any desired manner. For example, as a retardation film of which the retardation does not change dependently of the inclination angle to the slow axis direction, a film that satisfies Re≧50 nm and |Rth|≦15 nm can be favorably produced; and a film that satisfies Re≧100 nm and |Rth|≦10 nm can be produced more favorably.

The cellulose acylate film of the invention may be used as a retardation film directly as it is. Plural sheets of the cellulose acylate film of the invention may be laminated, or the cellulose acylate film of invention may be laminated with any other film not falling within the scope of the invention, and the resulting laminate films thus having suitably controlled Re and Rth may also be used as retardation films. For laminating the films, a paste or an adhesive may be used.

As the case may be, the cellulose acylate film of the invention may be used as a support of retardation films. An optically anisotropic layer of liquid crystal may be provided on the support to give a retardation film. The optical-anisotropic layer applicable to the retardation film of the invention may be formed of, for example, a composition containing a liquid crystalline compound or a polymer film having birefringence.

The liquid crystalline compound is preferably a discotic liquid crystalline compound or a rod-shaped liquid crystalline compound.

### [Discotic Liquid Crystalline Compound]

Examples of the discotic liquid crystalline compound usable in the invention are described in various publications (e.g., C. Destrade et al., Mol. Cryst. Liq. Cryst., Vol. 71, page 111 (1981); Quarterly Outline of Chemistry, No. 22, Chemistry of Liquid Crystal, Chap. 5, Chap. 10, Sec. 2 (1994), by the Chemical Society of Japan; B. Kohne et al., Angew. Chem. Soc. Chem. Comm., page 1794 (1985); J. Zhang et al., J. Am. Chem. Soc., Vol. 116, page 2655 (1994)).

Preferably, the discotic liquid crystalline molecules are fixed as aligned in the optically anisotropic layer; and most preferably, they are fixed through polymerization. The polymerization of discotic liquid crystalline molecules is described in JP-A-8-27284. For fixing discotic liquid crystalline molecules through polymerization, it is necessary that a substituent of a polymerizing group is bonded to the disc core of the discotic liquid crystalline molecules. However, when a polymerizing group is directly bonded to the disc core, then the molecules could hardly keep their alignment condition during the polymerization. Accordingly, a linking group is introduced between the disc core and the polymerizing group. The discotic liquid crystalline molecules having a polymerizing group are disclosed in JP-A-2001-4387.

### [Rod-Shaped Liquid Crystalline Compound]

Examples of the rod-shaped liquid crystalline compound usable in the invention are azomethines, azoxy compounds, cyanobiphenyls, cyanophenyl esters, benzoates, phenyl cyclohexanecarboxylates, cyanophenylcyclohexanes, cyano-substituted phenylpyrimidines, alkoxy-substituted phenylpyrimidines, phenyldioxanes, tolans and alkenylcyclohexylbenzonitriles. However, not limited to such low-molecular rod-shaped liquid crystalline compounds, also usable herein are high-molecular rod-shaped liquid crystal compounds.

In the optically anisotropic layer, the rod-shaped liquid crystalline molecules are preferably fixed as aligned therein; and most preferably, they are fixed through polymerization. Examples of the polymerizing rod-shaped liquid crystalline compound usable in the invention are described, for example, in Macromol. Chem., Vol. 190, page 2255 (1989); Advanced materials, Vol. 5, page 107 (1993); U.S. Pat. No. 4,683,327, U.S. Pat. No. 5,622,648, U.S. Pat. No. 5,770,107; WO95/22586, WO95/24455, WO97/00600, WO98/23580, WO98/52905; JP-A-1-272551, JP-A-6-16616, JP-A-7-110469, JP-A-11-80081 and JP-A-2001-328973.

### (Optically Anisotropic Layer of Polymer Film)

The optically anisotropic layer may be formed of a polymer film. The polymer film may be made of a polymer capable of expressing optical anisotropy. Examples of the polymer capable of expressing optical anisotropy are polyolefins (e.g., polyethylene, polypropylene, norbornenic polymer), polycarbonates, polyarylates, polysulfones, polyvinyl alcohols, polymethacrylates, polyacrylates, and cellulose esters (e.g., cellulose triacetate, cellulose diacetate). The polymer may be a copolymer or a polymer mixture of these polymers.

### <<Polarizer>>

The cellulose acylate film or the retardation film of the invention may be used as a protective film of a polarizer (polarizer of the invention). The polarizer of the invention comprises a polarizing film and two polarizer-protective films (cellulose acylate films) that protect both surfaces of the film, in which the cellulose acylate film or the retardation film of the invention may be used as at least one of the polarizer-protective films.

In case where the cellulose acylate film of the invention is used as the polarizer-protective film, then it is desirable that the cellulose acylate film of the invention is subjected to the above-mentioned surface treatment (described also in JP-A-6-94915, JP-A-6-118232) for hydrophilication. For example, the film is preferably subjected to glow discharge treatment, corona discharge treatment or alkali saponification treatment. In particular, when the polymer to constitute the cellulose acylate film of the invention is cellulose acylate, then the surface treatment is most preferably alkali saponification treatment.

For the polarizing film, for example, herein usable is a polyvinyl alcohol film dipped and stretched in an iodine solution. In case where such a polyvinyl alcohol dipped and stretched in an iodine solution is used as the polarizing film, then the treated surface of the cellulose acylate film of the invention may be directly stuck to both surfaces of the polarizing film with an adhesive. In the production method of the invention, it is desirable that the cellulose acylate film is directly stuck to the polarizing film in that manner. The adhesive may be an aqueous solution of polyvinyl alcohol or polyvinyl acetal (e.g., polyvinyl butyral), or a latex of vinylic polymer (e.g., polybutyl acrylate). An especially preferred example of the adhesive is an aqueous solution of completely-saponified polyvinyl alcohol.

In a liquid crystal display device, in general, a liquid crystal cell is provided between two polarizers, and therefore, the device has four polarizer-protective films. The cellulose acylate film of the invention may be used as any of the four polarizer-protective films. Especially advantageously in such a liquid crystal display device, the cellulose acylate film of the invention is used as the protective film to be disposed between the polarizing film and the liquid crystal layer (liquid crystal cell). On the protective film to be disposed on the opposite side to the cellulose acylate film of the invention via the polarizing film therebetween, optionally provided is a transparent hard-coat layer, an antiglare layer or an antireflection layer. In particular, the film of the invention is favorably used as the polarizer-protective film on the outermost side of the display panel of a liquid crystal display device.

### <<Liquid Crystal Display Device>>

The transparent polymer film, the retardation film and the polarizer of the invention may be used in liquid crystal display devices of various display modes. Liquid crystal display modes to which the films are applicable are described below. Of those modes, the transparent polymer film, the retardation film and the polarizer of the invention are favorably used in liquid crystal display devices of VA mode and IPS mode. The liquid crystal display devices may be any of transmission type, reflection type or semi-transmission type.

### (TN-Type Liquid Crystal Display Device)

The transparent polymer film of the invention may be used as a support of the retardation film in a TN-type liquid crystal display device having a TN-mode liquid crystal cell. TN-mode liquid crystal cells and TN-type liquid crystal display devices are well known from the past. The retardation film to be used in TN-type liquid crystal display devices is described in JP-A-3-9325, JP-A-6-148429, JP-A-8-50206, JP-A-9-26572; and Mori et al's reports (Jpn. J. Appl. Phys., Vol. 36 (1997), p. 143; Jpn. J. Appl. Phys., Vol. 36 (1997), p. 1068).

### (STN-Type Liquid Crystal Display Device)

The transparent polymer film of the invention may be used as a support of the retardation film in an STN-type liquid crystal display device having an STN-mode liquid crystal cell. In general, in an STN-type liquid crystal display device, the rod-shaped liquid crystalline molecules in the liquid crystal cell are twisted within a range of from 90 to 360 degrees, and the product (Δnd) of the refractive anisotropy (Δn) of the rod-shaped liquid crystalline molecule and the cell gap (d) is within a range of from 300 to 1500 nm. The retardation film to be used in STN-type liquid crystal display devices is described in JP-A-2000-105316.

### (VA-Type Liquid Crystal Display Device)

The transparent polymer film of the invention is especially advantageously used as the retardation film or as a support of the retardation film in a VA-type liquid crystal display device having a VA-mode liquid crystal cell. The VA-type liquid crystal display device may be a multi-domain system, for example, as in JP-A-10-123576. In these embodiments, the polarizer that comprises the transparent polymer film of the invention contributes to enlarging the viewing angle of the display panel and to improving the contrast thereof.

### (IPS-Type Liquid Crystal Display Device and ECB-Type Liquid Crystal Display Device)

The transparent polymer film of the invention is especially advantageously used as the retardation film, as a support of the retardation film or as a protective film of the polarizer in an IPS-type liquid crystal display device and an ECB-type liquid crystal display device having an IPS-mode or ECB-mode liquid crystal cell. In the devices of these modes, the liquid crystal material is aligned nearly in parallel in black display, or that is, the liquid crystal molecules are aligned in parallel to the substrate face while no voltage is applied thereto, thereby giving black display. In these embodiments, the polarizer that comprises the transparent polymer film of the invention contributes to enlarging the viewing angle of the display panel and to improving the contrast thereof.

### (OCB-Type Liquid Crystal Display Device and HAN-Type Liquid Crystal Display Device)

The transparent polymer film of the invention is also especially advantageously used as a support of the retardation film in an OCB-type liquid crystal display device having an OCB-mode liquid crystal cell and in a HAN-type liquid crystal display device having a HAN-mode liquid crystal cell. The retardation film to be used in an OCB-type liquid crystal display device and a HAN-type liquid crystal display device is preferably so designed that the direction in which the absolute value of the retardation of the film is the smallest does not exist both in the in-plane direction of the retardation film and in the normal direction thereof. The optical properties of the retardation film to be used in an OCB-type liquid crystal display device and a HAN-type liquid crystal display device may vary depending on the optical properties of the optically anisotropic layer therein, the optical properties of the support therein and the relative positioning of the optically anisotropic layer and the support therein. The retardation film to be used in an OCB-type liquid crystal display device and a HAN-type liquid crystal display device is described in JP-A-9-197397. It is described also in a Mori et al's report (Jpn. J. Appl. Phys., Vol. 38 (1999), p. 2837).

### (Reflection-Type Liquid Crystal Display Device)

The transparent polymer film of the invention may be advantageously used also as the retardation film in TN-mode, STN-mode, HAN-mode and GH (guest-host)-mode reflection-type liquid crystal display devices. These display modes are well known from the past. TN-mode reflection-type liquid crystal display devices are described in JP-A-10-123478, WO98/48320, and Japanese Patent 3022477. The retardation film for use in reflection-type liquid crystal display devices is described in WO00/65384.

### (Other Liquid Crystal Display Devices)

The transparent polymer film of the invention may be advantageously used also as a support of the retardation film in an ASM (axially symmetric aligned microcell)-type liquid crystal display device having an ASM-mode liquid crystal cell. The ASM-mode liquid crystal cell is characterized in that the cell thickness is held by a position-adjustable resin spacer. The other properties of the cell are the same as those of the TN-mode liquid crystal cell. The ASM-mode liquid crystal cell and the ASM-type liquid crystal display device are described in a Kume et al's report (Kume et al., S/D 98 Digest 1089 (1988)).

### (Hard Coat Film, Antiglare Film, Antireflection Film)

As the case may be, the transparent polymer film of the invention may be applied to a hard coat film, an antiglare film and an antireflection film. For the purpose of improving the visibility of flat panel displays such as LCD, PDP, CRT, EL, any or all of a hard coat layer, an antiglare layer and an antireflection layer may be given to one or both surfaces of the transparent polymer film of the invention. Preferred embodiments of such antiglare film and antireflection film are described in detail in Hatsumei Kyokai Disclosure Bulletin (No. 2001-1745, issued Mar. 15, 2001, Hatsumei Kyokai), pp. 54-57, and are preferably employed also for the transparent polymer film of the invention.

### <<Measuring Method>>

Hereinafter, methods of measuring and evaluating the characteristics used in the following Examples will be described.

### [Retardation]

Sampling was carried out at five portions in the width direction (center, edge portions (5% of the overall width from both edges), and respective two portions at the intermediate of the center and the edges) every 100 m in the longitudinal direction, and 2 cm-square samples were taken out and evaluated according to the above-described method. Then, the values for respective portions were averaged to give Re and Rth. Further, the difference between the maximum and the minimum values of declination (unit: °, a value can be −45° to +45°) in the direction of the slow phase axis from the transport direction or the direction perpendicular thereto at respective positions was obtained as the fluctuation range in the direction of the slow phase axis.

### [Haze]

Sampling was carried out at five portions in the width direction of the film (center, edge portions (5% of the overall width from both edges), and respective two portions at the intermediate of the center and the edges). Then, the values for respective portions evaluated according to the above-mentioned method were averaged, thereby determining the haze value.

### [Tm₀]

Tm₀ of a film was determined by the method described above.

### [Polarization Degree]

Two sheets of the polarizer produced herein were stuck together with their absorption axes kept in parallel to each other and the transmittance (Tp) thereof was measured; and the two sheets were stuck together with their absorption axes kept perpendicular to each other and the transmittance (Tc) thereof was measured. The polarization degree (P) of the polarizer was calculated in accordance with the following formula:

Polarization Degree P=((Tp−Tc)/(Tp+Tc))^{0.5}

Hereinafter, the characteristics of the invention will be more concretely described with reference to the following Examples and Comparative Examples. In the following Examples, materials, the amount and the ratio thereof, details of the treatment, and the treatment process may be suitably modified within the range of not impairing the purpose of the invention. Accordingly, the invention should not be limitatively interpreted by the Examples mentioned below.

### EXAMPLES 101 TO 118, COMPARATIVE EXAMPLES 101 TO 103

### Preparation of Polymer Solution

### 1) Cellulose Acylate

In respective Examples and Comparative Examples, the cellulose acylates A to F described later were used according to Table 1. Each cellulose acylate was heated and dried at 120° C. to have a water content of 0.5% by mass or less. After that, 15 parts by mass of cellulose acylate was used.

Cellulose Acylate A:

A powder of cellulose acetate having a substitution degree of 2.91 originated from a pulp was used. Cellulose acylate A had a viscosity-average polymerization degree of 270 and a substitution degree of 6-acetyl group of 0.93. The average diameter of the powder particles was 1.5 mm and the standard deviation thereof was 0.5 mm.

Cellulose Acylate B:

A powder of cellulose acetate having a substitution degree of 2.94 originated from a pulp was used. Cellulose acylate B had a viscosity-average polymerization degree of 300 and a substitution degree of 6-acetyl group of 0.94.

Cellulose Acylate C:

LT-35 manufactured by Daicel Chemical Ind., Ltd. was purchased and used. Cellulose acylate C had a substitution degree of 2.92, a viscosity-average polymerization degree of 300, and a substitution degree of 6-acetyl group of 0.94.

Cellulose Acylate D:

A powder of cellulose acetate having a substitution degree of 2.76 originated from a pulp was used. Cellulose acylate D had a viscosity-average polymerization degree of 300 and a substitution degree of 6-acetyl group of 0.90.

Cellulose Acylate E:

A powder of cellulose acetate having a substitution degree of 2.91 originated from a linter was used. Cellulose acylate E had a viscosity-average polymerization degree of 270 and a substitution degree of 6-acetyl group of 0.93. The average diameter of the powder particles was 1.5 mm and the standard deviation thereof was 0.5 mm.

Cellulose Acylate F:

A powder of cellulose acetate having a substitution degree of 2.88 originated from a pulp was used. Cellulose acylate F had a viscosity-average polymerization degree of 300 and a substitution degree of 6-acetyl group of 0.91. The average diameter of the powder particles was 1.5 mm and the standard deviation thereof was 0.5 mm.

### [Substitution Degree]

The substitution degree of acyl of cellulose acylate was determined by the use of ¹³C-NMR according to the method described in Carbohydr. Res. 273 (1995), pp. 83 to 91 (by Tezuka, et al).

### [Polymerization Degree]

The cellulose acylate produced herein is absolutely dried, then about 0.2 g thereof is accurately weighed, and dissolved in 100 mL of a mixed solvent of dichloromethane:ethanol=9:1 (mass ratio). Using an Ostwald viscometer, the time (second) taken by its dropping at 25° C. is measured, and the polymerization degree DP is calculated according to the following formulae.

ηᵣₑₗ=T/T₀

[η]=ln(ηᵣₑₗ)/C

DP=[η]/Km

wherein T indicates the time (second) taken by the dropping sample; T₀ indicates the time (second) taken by the dropping solvent alone; in indicates a natural logarithm; C indicates the concentration (g/L); and Km is 6×10⁻⁴.

### 2) Solvent

In respective Examples and Comparative Examples, either the following solvent A or B was used according to Table 1. Each solvent had the water content of 0.2% by mass or below.

Solvent A:

A mixed solvent in which dichloromethane/methanol/butanol (83/15/2 parts by mass) are mixed was used.

Solvent B:

A mixed solvent in which dichloromethane/methanol (92/8 parts by mass) are mixed was used.

### 3) Additive

In respective Examples and Comparative Examples, either an additive A or B having the following composition was used according to Table 1.

Additive A:

Silicon dioxide fine particles (particle size: 20 nm, Mohs hardness: about 7) (0.08 part by mass)

Additive B:

Triphenyl phosphate (1.2 parts by mass)

Biphenyldiphenyl phosphate (0.6 part by mass)

Silicon dioxide fine particles (particle size: 20 nm, Mohs hardness: about 7) (0.08 part by mass)

### 4) Swelling, Dissolution

In respective Examples and Comparative Examples, the dissolution processes A to C described later were used according to Table 1, and swelling and dissolution processes were carried out.

Dissolution Process A:

The solvent and the additive mentioned above were put into a 400-liter stainless dissolution tank, which has stirring blades and is cooled with cooling water that runs around its periphery. With stirring and dispersing them therein, the cellulose acylate was gradually added to the tank. After the addition, this was stirred at room temperature for 2 hours. After thus swollen for 3 hours, this was again stirred to obtain a cellulose acylate mixture.

For the stirring, used were a dissolver-type eccentric stirring shaft that runs at a peripheral speed of 15 m/sec (shear stress, 5×10⁴ kgf/m/sec^{2 [}4.9×10⁵ N/m/sec²]) and a stirring shaft that has an anchor blade at the center axis thereof and runs at a peripheral speed of 1 m/sec (shear stress, 1×10⁴ kgf/m/sec^{2 [}9.8×10⁴ N/m/sec²]). For the swelling, the high-speed stirring shaft was stopped and the peripheral speed of the anchor blade-having stirring shaft was reduced to 0.5 m/sec.

The swollen mixture in the tank was transported via a screw pump of which center part of the shaft was heated at 30° C., and passed through a cooling part, which was cooled from the periphery part of the screw, at −70° C. for 3 min. The cooling process was carried out by using refrigerant of −75° C. cooled in a refrigerator. The mixture obtained by the cooling process was transported to the stainless vessel via the screw pump of which column was heated at 30° C.

Next, this was stirred at 30° C. for 2 hours to obtain a cellulose acylate solution.

Dissolution Process B:

The solvent and the additive mentioned above were put into a 400-liter stainless dissolution tank, which has stirring blades and is cooled with cooling water that runs around its periphery. With stirring and dispersing them therein, the cellulose acylate was gradually added to the tank. After the addition, this was stirred at room temperature for 2 hours. After thus swollen for 3 hours, this was again stirred to obtain a cellulose acylate solution.

For the stirring, used were a dissolver-type eccentric stirring shaft that runs at a peripheral speed of 15 m/sec (shear stress, 5×10⁴ kgf/m/sec^{2 [}4.9×10⁵ N/m/sec²]) and a stirring shaft that has an anchor blade at the center axis thereof and runs at a peripheral speed of 1 m/sec (shear stress, 1×10⁴ kgf/m/sec^{2 [}9.8×10⁴ N/m/sec²]). For the swelling, the high-speed stirring shaft was stopped and the peripheral speed of the anchor blade-having stirring shaft was reduced to 0.5 m/sec.

The swollen solution in the tank was heated up to 50° C. via a jacketed pipe line, and then further heated up to 90° C. under a pressure of 2 MPa for complete dissolution. The heating time was 15 minutes. In this stage, the filter, the housing and the pipe line that are exposed to high temperature are all made of Hastelloy alloy having good corrosion resistance; and the system is covered with a jacket for circulating a heat carrier therethrough for keeping the system warmed and heated.

Next, this was cooled to 36° C. to obtain a cellulose acylate solution.

Dissolution Process C:

The solvent and the additive mentioned above were put into a 400-liter stainless dissolution tank, which has stirring blades and is cooled with cooling water that runs around its periphery. With stirring and dispersing them therein, the cellulose acylate was gradually added to the tank. After the addition, this was stirred at room temperature for 2 hours. After thus swollen for 3 hours, this was again stirred at 30° C. for 2 hours to obtain a cellulose acylate solution.

For the stirring, used were a dissolver-type eccentric stirring shaft that runs at a peripheral speed of 15 m/sec (shear stress, 5×10⁴ kgf/m/sec^{2 [}4.9×10⁵ N/m/sec²]) and a stirring shaft that has an anchor blade at the center axis thereof and runs at a peripheral speed of 1 m/sec (shear stress, 1×10⁴ kgf/m/sec^{2 [}9.8×10⁴ N/m/sec²]). For the swelling, the high-speed stirring shaft was stopped and the peripheral speed of the anchor blade-having stirring shaft was reduced to 0.5 m/sec.

### 5) Filtration

The cellulose acylate solution thus obtained was filtered through a paper filter sheet (#63, manufactured by Toyo Roshi Kaisha, Ltd.) having an absolute filtration accuracy of 10 μm, and then through a sintered metal filter sheet (FH025, manufactured by Pall Corporation) having an absolute filtration accuracy of 2.5 μm to obtain a polymer solution.

### (Production of Film)

In respective Examples and Comparative Examples, either an film-forming process A or B described later was used according to Table 1.

Film-Forming Process A:

The cellulose acylate solution was heated at 30° C., passed through a caster, Giesser (described in JP-A-11-314233), and cast onto a mirror-faced stainless support having a band length of 60 m and set at 15° C., at a casting speed of 50 m/min. The casting width was 200 cm. The space temperature in the entire casting zone was set at 15° C. At 50 cm before the end point of the casting zone, the cellulose acylate film thus cast and rolled was peeled off from the band, and exposed to drying air applied thereto at 45° C. Next, this was dried at 110° C. for 5 minutes and then at 140° C. for 10 minutes to obtain a transparent film of cellulose acylate having a thickness of 80 μm.

Film-Forming Process B:

The polymer solution was heated at 30° C., passed through a caster, Giesser, and cast onto a mirror-faced stainless support which is a drum having a diameter of 3 m. The temperature of the support was set at −5° C., a casting speed was set at 100 m/min, and the casting width was 200 cm. The space temperature in the entire casting zone was set at 15° C. At 50 cm before the end point of the casting zone, the cellulose acylate film thus cast and rolled was peeled off from the drum, and then the both ends of the film was clipped with pin tenters. The cellulose acylate film held with pin tenters was transported to a drying zone. At first, the film was exposed to drying air applied thereto at 45° C. Next, this was dried at 110° C. for 5 minutes and then at 140° C. for 10 minutes to obtain a transparent film of cellulose acylate having a thickness of 80 μm.

### (Heat Treatment)

The obtained film was subjected to heat treatment using an apparatus having a heating zone between two pairs of nip rolls. The length/breadth ratio (distance between two pairs of nip rolls/base width) was adjusted to be 3.3, the heating zone was kept at a temperature as shown in Table 1, and the film was cooled to a temperature of 25° C. after it was conveyed through two pairs of nip rolls. The elongation of the film was obtained according to the following formula in such a manner that gauge lines were given to the film at a constant interval in the direction perpendicular to the transport direction of the film and the interval was measured before and after the heat treatment.

Elongation of film (%)=100×{(interval of gauge lines after heat treatment)−(interval of gauge lines before heat treatment)}/interval of gauge lines before heat treatment

### (Evaluation of Transparent Polymer Film)

The respective transparent polymer films thus obtained were evaluated. The results are shown in Table 1 below.

The slow phase axis of Re of the film was observed in the width direction in Examples 101 to 118, and observed in the transport direction of the film in Comparative Examples 101 to 103. The variation (variation of values measured at five portions) of Re and Rth evaluated based on the above-mentioned method was at most ±1 nm and at most ±2 nm, respectively, for all the samples. The fluctuation range in the direction of the slow phase axis was below 1°.

TABLE 1

| | Cellulose Acylate | | | | | Film- | | {−285 × S + |
|---|---|---|---|---|---|---|---|---|
| | | Substitution | | | Dissolution | Forming | Tm₀ | 1000} |
| | Type | Degree | Solvent | Additive | Process | Process | [° C.] | [° C.] |
| Example 101 | A | 2.91 | A | A | A | A | 290 | 171 |
| Example 102 | A | 2.91 | A | A | A | B | 290 | 171 |
| Example 103 | A | 2.91 | A | B | A | B | 285 | 171 |
| Example 104 | B | 2.94 | A | A | A | A | 290 | 162 |
| Example 105 | C | 2.92 | A | A | A | A | 290 | 168 |
| Comparative | D | 2.76 | A | A | A | A | 285 | 213 |
| Example 101 | | | | | | | | |
| Example 106 | A | 2.91 | B | A | B | A | 290 | 171 |
| Example 107 | E | 2.91 | B | A | B | A | 290 | 171 |
| Example 108 | E | 2.91 | B | A | C | A | 290 | 171 |
| Example 109 | F | 2.88 | B | A | B | A | 290 | 179 |
| Example 110 | F | 2.88 | B | A | B | A | 290 | 179 |
| Example 111 | F | 2.88 | B | A | B | A | 290 | 179 |
| Example 112 | B | 2.94 | B | A | A | A | 290 | 162 |
| Example 113 | B | 2.94 | B | A | A | A | 290 | 162 |
| Example 114 | B | 2.94 | B | A | A | A | 290 | 162 |
| Example 115 | B | 2.94 | B | B | A | A | 285 | 162 |
| Comparative | B | 2.94 | B | A | A | A | 290 | 162 |
| Example 102 | | | | | | | | |
| Example 116 | B | 2.94 | B | A | A | A | 290 | 162 |
| Example 117 | B | 2.94 | B | A | A | A | 290 | 162 |
| Example 118 | B | 2.94 | B | A | A | A | 290 | 162 |
| Comparative | B | 2.94 | A | A | A | A | 290 | 162 |
| Example 103 | | | | | | | | |

| | Heat | | | | | | | |
|---|---|---|---|---|---|---|---|---|
| | Treatment | Film | | | | Slow phase | | |
| | Temper- | Elon- | Re | Rth | | axis | Moisture | |
| | ature Tp | gation | Average | Average | \|Rth\|/Re | Variation | permeability | Haze |
| | [° C.] | [%] | [nm] | [nm] | Average | [°] | [g/m² · day] | [%] |
| Example 101 | 200 | 20 | 86 | −44 | 0.51 | 0.1 | 390 | 0.2 |
| Example 102 | 200 | 20 | 120 | 15 | 0.13 | 0.1 | 390 | 0.1 |
| Example 103 | 240 | 40 | 270 | 2 | 0.01 | 0.1 | 300 | 0.2 |
| Example 104 | 200 | 20 | 100 | −50 | 0.5 | 0.2 | 380 | 0.2 |
| Example 105 | 200 | 20 | 89 | −44 | 0.49 | 0.1 | 400 | 0.2 |
| Comparative | 200 | 20 | 5 | 12 | 2.40 | 0.2 | 430 | 0.2 |
| Example 101 | | | | | | | | |
| Example 106 | 200 | 20 | 79 | −34 | 0.43 | 0.1 | 390 | 0.2 |
| Example 107 | 240 | 20 | 180 | −89 | 0.49 | 0.1 | 390 | 0.2 |
| Example 108 | 240 | 20 | 156 | −80 | 0.51 | 0.2 | 380 | 0.2 |
| Example 109 | 175 | 25 | 41 | −18 | 0.44 | 0.2 | 550 | 1.0 |
| Example 110 | 180 | 20 | 50 | −26 | 0.52 | 0.2 | 460 | 0.4 |
| Example 111 | 240 | 20 | 159 | −78 | 0.49 | 0.1 | 400 | 0.2 |
| Example 112 | 240 | 20 | 227 | −79 | 0.35 | 0.1 | 370 | 0.2 |
| Example 113 | 240 | 0 | 186 | −79 | 0.42 | 0.3 | 360 | 0.2 |
| Example 114 | 240 | 40 | 277 | −81 | 0.29 | 0.1 | 370 | 0.2 |
| Example 115 | 240 | 20 | 243 | −64 | 0.26 | 0.2 | 350 | 0.3 |
| Comparative | 150 | 20 | 3 | 2 | 0.67 | 0.1 | 580 | 1.3 |
| Example 102 | | | | | | | | |
| Example 116 | 160 | 20 | 43 | −21 | 0.49 | 0.2 | 400 | 0.7 |
| Example 117 | 180 | 20 | 78 | −39 | 0.50 | 0.1 | 390 | 0.2 |
| Example 118 | 220 | 20 | 178 | −72 | 0.40 | 0.1 | 380 | 0.2 |
| Comparative | 25 | 0 | 1 | −51 | 51.0 | 0.3 | 960 | 0.2 |
| Example 103 | | | | | | | | |

As shown in Table 1, the heat treatment was carried out according to the methods of the invention. Therefore, it was possible to provide the cellulose acylate film which satisfies the formula |Rth|/Re<0.5 and has low haze value, and in which a variation is reduced. On the contrary, in case where the heat treatment temperature was low, the range of retardation of the film which can be controlled was narrowed or the haze value of the film was increased.

### EXAMPLE 151

### Re-Stretching of Film

Stretching is carried out by grasping the both ends of the cellulose acylate film in Example 113 with tenter clips for stretching the film in the direction perpendicular to the transport direction in a heating zone. The temperature in the heating zone was 160° C. and the stretching ratio was 25%. The stretching ratio of the film was obtained according to the following formula in such a manner that gauge lines were given to the film at a constant interval in the direction parallel to the transport direction of the film and the interval was measured before and after the stretching.

Stretching ratio (%)=100×{(interval of gauge lines after stretching)−(interval of gauge lines before stretching)}/interval of gauge lines before stretching

The values of Re and Rth of the obtained film was measured, thereby obtaining Re=160 nm and Rth=−2 nm. The slow phase axis of Re of the film was observed in the width direction of the film.

### COMPARATIVE EXAMPLE 104

The cellulose acylate film before being subjected to the heat treatment in Example 102 was subjected to a method according to Example 5 described in JP-A-5-157911, thereby obtaining a birefringent film. The film had a fluctuation range of as large as 8° in the slow phase axis direction, and the variation (variation of values measured at five portions) of Re and Rth was large as ±25 nm for Re and ±43 nm for Rth.

### EXAMPLE 201

### Manufacture of Laminated Retardation Film

The cellulose acylate film of the invention can be used directly as the retardation film, but here, a retardation film having a controlled Rth/Re ratio was manufactured by sticking the film by the use of an adhesive in roll-to-roll operation.

FUJITAC TD80UF (manufactured by Fujifilm corporation) and the film in Example 112 were stuck to each other by the use of an adhesive in roll-to-roll operation, and then Re and Rth were measured by the aforementioned method to give Re=73 nm and Rth=2 nm. The slow phase axis of Re of the retardation film was observed in the width direction of the film.

### EXAMPLES 301 TO 319, COMPARATIVE EXAMPLES 301 TO 308

### Manufacture of Polarizer

The obtained film was subjected to saponification treatment, thereby manufacturing a polarizer.

### 1) Saponification of Film

A film A and film B shown in Table 2 below were dipped in a 1.5 mol/L of NaOH aqueous solution (saponification solution) that was temperature-controlled at 55° C. for 2 minutes and then washed with water. After that, the films were dipped in a 0.05 mol/L sulfuric acid aqueous solution for 30 seconds and further passed through a water washing bath. Then, the films were subjected to air knife treatment three times to remove water and retained in a drying zone at 70° C. for 15 seconds to be dried, thereby manufacturing saponified films.

### 2) Manufacture of Polarizing Layer

According to Example 1 described in JP-A-2001-141926, the film was stretched in a longitudinal direction by giving difference in circumferential velocities to two pairs of nip rolls, thereby preparing a polarizing layer having a thickness of 20 μm.

### 3) Sticking

The polarizing layer thus obtained and the two films (film A and film B respectively, whose combination in respective Examples and Comparative Examples is shown in Table 2 below) selected from the saponified films were disposed so that the saponified surfaces of the film faced to the polarizing film and sandwiched the polarizing layer, and then stuck to each other by the use of a 3% PVA (PVA-117H, manufactured by KURARAY Co., Ltd.) aqueous solution as an adhesive in such a manner that the polarizing axis crossed perpendicularly to the longitudinal direction of the film.

In Table 2, ‘TAC B’ indicates FUJITAC TD80UF (manufactured by Fujifilm corporation; moisture permeability=430 g/(m²·day) at 40° C. and a relative humidity of 90%) (80 μm in terms of thickness), ‘polycarbonate’ indicates Panlite C1400 (manufactured by TEIJIN CHEMICALS, Ltd.; moisture permeability=30 g/(m²·day) at 40° C. and a relative humidity of 90%) (80 μm in terms of thickness), ‘COP1’ indicates ARTON FILM (thickness: 80 μm, manufactured by JSR corporation; moisture permeability=30 g/(m²·day) at 40° C. and a relative humidity of 90%) (80 μm in terms of thickness), and ‘COP2’ indicates ZEONOR FILM (thickness: 100 μm, manufactured by ZEON; moisture permeability=0 g/(m²·day) at 40° C. and a relative humidity of 90%) (80 μm in terms of thickness).

In Comparative Example 304, the sticking was carried out by using a film which had been subjected to surface treatment replaced by corona treatment.

### (Evaluation of Polarizer)

### [Initial Polarization Degree]

The polarization degree of the polarizer was calculated according to the method described above. The result is shown in Table 2.

### [After Storage Polarization Degree 1]

The film A side of the polarizer was stuck to a glass plate with an adhesive, and was left under conditions of 60° C. and a relative humidity of 95% for 500 hours and the polarization degree after the lapse of time (after storage polarization degree) was calculated according to the aforementioned method. The results are shown in Table 2 below.

### [After Storage Polarization Degree 2]

The film A side of the polarizer was stuck to a glass plate with an adhesive, and was left under conditions of 90° C. and a relative humidity of 0% for 500 hours and the polarization degree after the lapse of time (after storage polarization degree) was calculated according to the aforementioned method. The results are shown in Table 2 below.

TABLE 2

| | | | initial | | |
|---|---|---|---|---|---|
| | | | Polarization | After Storage | After Storage |
| | | | Degree | Polarization | Polarization |
| | Film A | Film B | [%] | Degree 1 [%] | Degree 2 [%] |
| Example 301 | Example 101 | TAC B | 99.9 | 99.9 | 99.9 |
| Example 302 | Example 102 | TAC B | 99.9 | 99.9 | 99.9 |
| Example 303 | Example 103 | TAC B | 99.9 | 99.9 | 99.9 |
| Example 304 | Example 104 | TAC B | 99.9 | 99.9 | 99.9 |
| Example 305 | Example 105 | TAC B | 99.9 | 99.9 | 99.9 |
| Example 306 | Example 106 | TAC B | 99.9 | 99.9 | 99.9 |
| Example 307 | Example 107 | TAC B | 99.9 | 99.9 | 99.9 |
| Example 308 | Example 108 | TAC B | 99.9 | 99.9 | 99.9 |
| Example 309 | Example 109 | TAC B | 99.9 | 99.9 | 99.9 |
| Example 310 | Example 110 | TAC B | 99.9 | 99.9 | 99.9 |
| Example 310 | Example 111 | TAC B | 99.9 | 99.9 | 99.9 |
| Example 311 | Example 112 | TAC B | 99.9 | 99.9 | 99.9 |
| Example 312 | Example 113 | TAC B | 99.9 | 99.9 | 99.9 |
| Example 313 | Example 114 | TAC B | 99.9 | 99.9 | 99.9 |
| Example 314 | Example 115 | TAC B | 99.9 | 99.9 | 99.9 |
| Example 315 | Example 116 | TAC B | 99.9 | 99.9 | 99.9 |
| Example 316 | Example 117 | TAC B | 99.9 | 99.9 | 99.9 |
| Example 317 | Example 118 | TAC B | 99.9 | 99.9 | 99.9 |
| Example 318 | Example 151 | TAC B | 99.9 | 99.9 | 99.9 |
| Example 319 | Example 115 | Example 115 | 99.9 | 99.9 | 99.9 |
| Comparative | Polycarbonate | Polycarbonate | (Unmeasurable due to insufficient sticking property) | | |
| Example 301 | | | | | |
| Comparative | COP1 | COP1 | (Unmeasurable due to insufficient sticking property) | | |
| Example 302 | | | | | |
| Comparative | COP2 | COP2 | (Unmeasurable due to insufficient sticking property) | | |
| Example 303 | | | | | |
| Comparative | COP2 | COP2 | 99.9 | 99.9 | (Bubble |
| Example 304 | | | | | generation) |
| Comparative | Comparative | TAC B | 99.9 | 99.9 | 99.9 |
| Example 305 | Example 101 | | | | |
| Comparative | Comparative | TAC B | 99.9 | 99.9 | 99.9 |
| Example 306 | Example 102 | | | | |
| Comparative | Comparative | TAC B | 99.9 | 99.9 | 99.9 |
| Example 307 | Example 103 | | | | |
| Comparative | TAC B | TAC B | 99.9 | 99.9 | 99.9 |
| Example 308 | | | | | |

### (Implementation Evaluation for IPS Type Liquid Crystal Display Device)

When each of the polarizers in Examples 312 and 318 was set in an IPS type liquid crystal display device (32 V type high vision liquid crystal television monitor (W32-L7000), manufactured by HITACHI, Ltd.) in place of a polarizer having been set in the monitor, viewing angle properties were improved. On the contrary, when each of the polarizers in Comparative Examples 305 to 308 was set, the viewing angle properties were either not improved or insufficiently improved.

### INDUSTRIAL APPLICABILITY

According to the invention, it is possible to provide a cellulose acylate film of which Re and Rth can be adjusted within the desired range and which has uniform optical anisotropy and excellent transparency; and to provide a cellulose acylate film which has such an optical property and is capable of being directly stuck to a polarizing film. In particular, it is possible to provide a cellulose acylate film which satisfies the following formulae Re≧40 and |Rth|/Re<0.5 and in which a variation is reduced; and to provide an excellent retardation film. In addition, the cellulose acylate film of the invention has suitable moisture permeability and therefore the film can be stuck to the polarizing film in on-line operation. For that reason, it is possible to provide polarizers excellent in visibility with high productivity. Further, it is possible to provide liquid crystal display devices having high reliability. Consequently, the invention has high industrial applicability.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 069524/2006 filed on Mar. 14, 2006 and Japanese Patent Application No. 060098/2007 filed on Mar. 9, 2007, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A cellulose acylate film which satisfies the following formula (I) and has a substitution degree of acyl substituted for hydroxyl group of cellulose of 2.88 or higher.
Re≧40 Formula (I)
wherein Re indicates a retardation (unit: nm) in the in-plane direction.

2. The cellulose acylate film according to claim 1, which satisfies the following formula (II).

|Rth|/Re<0.5 Formula (II)
wherein Re indicates a retardation (unit: nm) in the in-plane direction, and Rth indicates a retardation (unit: nm) in the thickness direction.

3. The cellulose acylate film according to claim 1, which has moisture permeability of 100 to 400 g/(m²·day) at 40° C. and a relative humidity of 90%.

4. The cellulose acylate film according to claim 1, which has haze of 1.0% or below.

5. The cellulose acylate film according to claim 1, wherein cellulose acylate is cellulose acetate.

6. A method for producing a cellulose acylate film which comprises transporting a cellulose acylate film having a substitution degree of acyl substituted for hydroxyl group of cellulose of 2.88 or higher, and subjecting the film to heat treatment at 160° C. or higher.

7. The method for producing a cellulose acylate film according to claim 6, which comprises subjecting the film to heat treatment at the heating temperature Tp (unit: ° C.) which satisfies the following formula (III).
{−285×S+1000}≦Tp<Tm₀ Formula (III)
wherein S indicates a substitution degree of acyl group substituted for hydroxyl group of cellulose and Tm₀ (unit: ° C.) indicates the melting point of cellulose acylate before being subjected to the heat treatment.

8. The method for producing a cellulose acylate film according to claim 6, wherein the cellulose acylate film is formed from dope obtained through a process of cooling a mixture containing cellulose acylate and a halogen-containing organic solvent at a temperature in the range of −100 to 10° C.

9. The method for producing a cellulose acylate film according to claim 6, wherein the mixture containing cellulose acylate and a halogen-containing organic solvent is subjected to at least one of the following methods (a) and (b) to dissolve the cellulose acylate in the solvent, and then the film is formed.
(a): A mixture is swollen at −10 to 39° C., and then heated at 0 to 39° C.
(b): A mixture is swollen at −10 to 39° C., and then heated at 40 to 240° C. under pressure of 0.2 to 30 MPa. After that, the mixture is cooled at 0 to 39° C.

10. A cellulose acylate film produced by the method of claim 6.

11. A retardation film which has at least one sheet of the cellulose acylate film of claim 1.

12. A polarizer which has at least one sheet of the cellulose acylate film of claim 1.

13. The polarizer according to claim 12, wherein the cellulose acylate film is directly stuck to a polarizing film.

14. A liquid crystal display device which has at least one sheet of the cellulose acylate film of claim 1.
